(19) United States
(12) Patent Application Publication
(10) Pub. No.: US 2006/0102025 A1
(43) Pub. Date: May 18, 2006

(54) Method for hydrophilizing screen printing stencil carriers and method for removing stencil material from a screen printing stencil carrier, and coating-removal fluid therefor

(76) Inventor: Gunter Wittemann, Dielheim (DE)

Correspondence Address: BERENATO, WHITE & STAVISH, LLC, 6550 ROCK SPRING DRIVE, SUITE 240, BETHESDA, MD, 20817, US

(21) Appl. No.: 11/271,952

(22) Filed: Nov. 14, 2005

(30) Foreign Application Priority Data
Nov. 15, 2004 (DE) 102004055113.8-45

(51) Int. Cl. B41M 1/12

(52) U.S. Cl. 101/129

(57) ABSTRACT

A method, apparatus and agent for hydrophilizing screen printing stencil carriers is disclosed. The screen printing stencil carrier is treated with a hydrophilizing agent prior to the application of stencil material. The hydrophilizing agent contains ultra-fine oxide particles and a wetting agent.

### CROSS-REFERENCE TO RELATED APPLICATIONS AND CLAIM TO PRIORITY

This application is related to application number 10 2004 055 113.8-45, filed Nov. 15, 2004 in the Federal Republic of Germany, the disclosure of which is incorporated herein by reference and to which priority is claimed.

### FIELD OF THE INVENTION

The invention relates to a method for hydrophilizing screen printing stencil carriers, in which the screen printing stencil carrier is treated with a hydrophilizing agent prior to the application of stencil material. It relates further to a method for removing stencil material from a screen printing stencil carrier, in which a coating-removal fluid that contains a coating-removal agent and a wetting agent is applied onto the screen printing stencil carrier and onto the stencil material. Lastly, the invention concerns a coating-removal fluid for removing stencil material from a stencil carrier.

### BACKGROUND OF THE INVENTION

For production of a screen printing form, a screen printing stencil carrier, usually in the form of a screen printing fabric, is coated with a stencil material (also called copy material) that is water-soluble and sensitive to UV light. After drying, the portion of the stencil material that is intended to permanently close off the screen printing stencil carrier is irradiated with UV light, e.g. by means of a transparency. This causes the stencil to crosslink and become water-insoluble in the region in which it is impinged upon by UV light. The regions not exposed to the UV light remain water-soluble and are washed out after the exposure process, so that the screen printing stencil carrier is permeable to the printing ink in those regions. The result is a screen printing stencil.

Usual stencil material is made up substantially of a water-soluble base polymer, homopolymeric or copolymeric dispersions, plasticizers, and resins and additives. The principal constituent is water. Because screen printing stencil carriers are usually made of plastic fabrics, they are hydrophobic. This creates difficulties when wetting the screen printing stencil carrier with the aqueous stencil material, causing defects that negatively affect the quality of the printing result.

To avoid this problem, the screen printing stencil carrier is treated, before application of the stencil material, with a degreasing agent substantially comprising a nonionic surfactant and water. This does not, however, produce a sufficiently long-lasting hydrophilizing effect, and the hydrophilizing effectiveness is also low.

### SUMMARY OF THE INVENTION

The object of the invention is on the one hand to make available methods with which effective hydrophilizing of a screen printing stencil carrier can be achieved, application of which also permits a substantial improvement in the wetting of the screen printing stencil carrier with stencil material. The object also consists in making available an agent suitable therefor.

The first part of the object is achieved, according to the present invention, by a method in which a hydrophilizing agent containing ultra-fine oxide particles and a wetting agent is used. Upon application of this hydrophilizing agent before stencil material is placed onto the screen printing stencil carrier, the latter is hydrophilized in extraordinarily effective and long-lasting fashion, with the consequence that the screen printing stencil carrier is wetted by the stencil material substantially better than with the agents of the existing art, and visually detectable defects occur very seldom or are entirely absent.

It is known from DE 101 16 200 A2 to equip surfaces such as glass, plastic, metal, and ceramic with a hydrophilic coating composition that comprises ultra-fine oxide particles and a surface modifier. This is intended to cause small water droplets, such as those that are deposited e.g. as a result of condensation effects, to coalesce into a continuous film so that they are no longer visually disruptive (anti-fog effect). A further intention is to promote the drying of wetted surfaces and to achieve an anti-soiling effect. Applications that are cited are the treatment of mirrors, heat exchangers, articles of clothing, waterless urinals, bandages, diapers, paper, and cellulose.

In an embodiment of the invention, provision is made for the oxide particles to have a particle size in the nanometer range, usefully between 2 and 100 nm, preferably between 2 and 40 nm. Suitable oxide particles are principally metal oxides such as titanium oxides, but most of all aluminum oxide and zirconium oxide, but also sheet silicates and/or mixtures thereof. They can be modified and/or functionalized by being modified with ions from the group of the alkaline or alkaline-earth ions and/or with inorganic or organic salts that are present in compounds with aluminum, zirconium, zinc, or titanium. In addition, functional groups of the organic side chains of epoxy, acryloxy, methacryloxy, glycidyloxy, alkyl, vinyl, carboxyl, mercapto, hydroxyl, amide, amino, isocyano, or silanol groups may be inserted. The proportion of oxide particles in the hydrophilizing agent should be between at least 0.15 and at most 29.7 wt %. The wetting agent that is likewise present according to the present invention is usefully a surfactant, in particular a nonionic surfactant. Examples thereof are nonionic surfactant including ethoxylate or alkoxylate of primary and secondary fatty alcohols or of alkylphenols, an ethylene oxide/propylene oxide or propylene oxide/ethylene oxide block polymer, an aminoethoxylate, an aminoalkoxylate, an alkylpolyglycolide, a fatty amine oxide, a fatty acid alkanolamide, and/or a fatty acid alkylglucamide. Preferably, the surfactant is an end-capped surfactant in-which the hydroxyl group is etherified with an alkyl group. The wetting agent should be present in the hydrophilizing agent at a concentration from at least 0.01 to at most 20 wt %. The remainder in each case is usefully water.

As an alternative to the method described above, hydrophilization of the screen printing stencil carrier can also be accomplished by the fact that the above-described hydrophilizing agent according to the present invention is used in the context of the removal of stencil material from the screen printing stencil carrier, in a form such that it is added to the coating-removal fluid containing a coating-removal agent. Upon removal of the screen printing stencil carrier in order to produce a new screen printing stencil, the screen printing stencil carrier not only has the stencil material taken off it, but at the same time is also hydrophilized for the next coating operation, and in substantially more effective fashion than with the known degreasing agents. A special hydrophilizing step is then not necessary. In contrast to the first method mentioned above, the wetting agent should be present at a concentration from at least 0.01 to at most 20 wt %.

As known per se, the coating-removal agent contains an oxidizing agent; an iodate, in particular a periodate, and/or a periodic acid, preferably a sodium metaperiodate, are particularly appropriate here. Corresponding compositions are evident, for example, from DE-A-27 25 499 and DE 200 22 468 U1. The oxidizing agent should be present in the coating-removal fluid at a concentration from at least 0.1 to at most 5 wt %.

The coating-removal fluid can, in addition, also contain an organic solvent, preferably selected from the group of the amides, ethers, esters, ether esters, and/or ketones (linear or cyclic), for example butyrolactone (4-hydroxybutyric acid lactone). This can be present in the coating-removal fluid at a concentration from 1 to 30 wt %.

To stabilizing the oxidizing agent, it is recommended to add preferably concentrated sulfuric acid and/or nitric acid, at a concentration from at least 0.1 to at most 5 wt % relative to the coating-removal fluid. It is understood that the maximum values for the individual constituents of the coating-removal fluid can in each case be only so great that addition of the individual constituents does not yield more than 100 wt %.

The second part of the object is achieved, according to the present invention, by a coating-removal fluid for the removal of stencil material from a screen printing stencil carrier, which fluid has the composition described above. In addition, the coating-removal fluid can also have dyes or pigments added to it. Additives such as dispersing. adjuvants, complexing agents, and/or defoaming agents are usually also present in supplementary fashion. Experience with known coating-removal fluids may be drawn upon in this context. Application of the coating-removal fluid and of the hydrophilizing agent can be accomplished both manually and mechanically.

The usual compositions of both the hydrophilizing agent and the coating-removal fluid are indicated below, with ranges indicated for the individual constituents. Within the ranges indicated, only those values that result in a 100 wt % total for the constituents are appropriate.

Hydrophilizing Agent

| | |
|---|---|
| 0.01-50 wt % | Nonionic surfactant based on fatty alcohol |
| | polyalkylene glycol ethers (e.g. the “Propetal 99” |
| | product of Zschimmer & Schwarz GmbH & Co., |
| | D-56112 Lahnstein/Rhein) |
| 0.15-29.7 wt % | Ultra-fine particulate oxides, e.g. zirconium oxide or |
| | aluminum oxide |
| remainder | Water |

Coating-Removal Agent

| | | |
|---|---|---|
| 1. | 0.1-5% | Sodium metaperiodate |
| | 0.05-5% | Concentrated nitric acid |
| | 0.01-50% | Nonionic surfactant (e.g. the “Propetal 99” product of |
| | | Zschimmer & Schwarz GmbH & Co., D-56112 |
| | | Lahnstein/Rhein) |
| | 0.15-27% | Oxide, e.g. zirconium oxide or aluminum oxide |
| | remainder | Water |
| 2. | 0.1-5% | Sodium metaperiodate |
| | 0.05-5% | Concentrated nitric acid |
| | 0.01-50% | Nonionic surfactant (e.g. the “Propetal 99” product of |
| | | Zschimmer & Schwarz GmbH & Co., D-56112 |
| | | Lahnstein/Rhein) |
| | 0.15-27% | Oxide, e.g. zirconium oxide or aluminum oxide |
| | 1-30% | Organic solvent, e.g. a butyrolactone product |
| | remainder | Water |

The table below shows the effectiveness of the hydrophilizing agent according to the present invention and of the coating-removal fluid according to the present invention, as compared with known agents. In each case, a screen printing fabric having a mesh size of 34 μm was treated with the substances indicated below. The treatment was performed as follows:

The hydrophilizing agent or coating-removal agent was sprayed on and distributed evenly using a brush. After a short residence time on the screen printing fabric, it was rinsed off with water using an ordinary hand sprayer, and dried: The contact angle with water was then measured, and the screen printing fabric was then coated with a commercially available photoemulsion (stencil material). The resulting surface quality was evaluated visually.

For the evaluation of the coating-removal fluid, the untreated screen printing fabric was coated with a commercially available photoemulsion (stencil material), exposed, and dried. The coating-removal fluid was then distributed evenly over the stencil using a brush, and the stencil that had thereby been partially dissolved by oxidation was removed with a commercially available high-pressure unit. After drying of the screen printing fabric, the contact angle with water was measured and the screen printing fabric was then coated again with the same photoemulsion. The resulting surface quality of the stencil thus formed was evaluated visually.

### Hydrophilizing Agent

| All quantities as wt % | | Contact angle with water (degrees) |
|---|---|---|
| Example 1 | | |
| (Hydrophilizing agent) | | |
| 1 | Propetal 99 | 50-60 |
| 3 | Zirconium oxide | |
| 96 | Water | |
| Example 2 | | |
| (Hydrophilizing agent) | | |
| 1 | Propetal 99 | 40-50 |
| 0.3 | Aluminum oxide | |
| 98.7 | Water | |
| Example 3 | | |
| (Hydrophilizing agent) | | |
| 1 | Propetal 99 | 35-40 |
| 9 | Aluminum oxide | |
| 90 | Water | |
| Example 4 | | |
| (Hydrophilizing agent) | | |
| 1 | Propetal 99 | 30-35 |
| 29.7 | Aluminum oxide | |
| 69.3 | Water | |
| Comparative example 1 | | 90-100 |
| (untreated fabric) | | |
| Comparative example 2 | | |
| (degreasing agent) | | |
| 1 | Propetal 99 | 80-90 |
| 99 | Water | |

### Coating-Removal Agent

| | |
|---|---|
| All quantities as wt % | Contact angle with water (degrees) |

Example 5
(Coating-removal fluid)

| | | |
|---|---|---|
| 0.5 | Sodium metaperiodate | 50-55 |
| 0.05 | Concentrated nitric acid | |
| 1 | Propetal 99 | |
| 3 | Aluminum oxide | |
| 95.45 | Water | |

Example 6
(Coating-removal fluid with cleaning)

| | | |
|---|---|---|
| 0.5 | Sodium metaperiodate | 55-60 |
| 0.05 | Concentrated nitric acid | |
| 1 | Propetal 99 | |
| 3 | Aluminum oxide | |
| 10 | Butyrolactone | |
| 85.45 | Water | |

Comparative example 5

| | | |
|---|---|---|
| 0.5 | Sodium metaperiodate | 90-100 |
| 0.05 | Concentrated nitric acid | |
| 1 | Propetal 99 | |
| 98.45 | Water | |

It is evident from the tables above that with the conventional degreasing agent (Comparative example 2) and with the known coating-removal fluid, no significant reduction in the contact angle with water can be achieved, so that the wettability of the screen printing fabric is practically no different from that of an untreated screen printing fabric (Comparative example 1). Only with the use of the hydrophilizing agent according to the present invention or the coating-removal fluid according to the present invention, based on ultra-fine oxide particles, is a definite hydrophilization of the screen printing fabric achieved, as Examples 1 to 6 show. A subsequent (re)coating of the screen printing fabric with stencil material shows the desired effect. Because of the substantially better wetting behavior, defects were almost or indeed entirely undetectable visually. The surface of the stencil was visually much more uniform than when the substances according to the comparative examples were used.

I claim:

1. A method for hydrophilizing screen printing stencil carriers, in which the screen printing stencil carrier is treated with a hydrophilizing agent prior to the application of stencil material,
wherein a hydrophilizing agent containing ultra-fine oxide particles and a wetting agent is used.

2. The method according to claim 1, wherein the oxide particles have a particle size in the nanometer range.

3. The method according to claim 2, wherein the particle size of the oxide particles is from 2 to 100 nm, preferably 2 to 40 nm.

4. The method according to claim 1, wherein the oxide particles comprise metal oxide(s), in particular titanium oxide, aluminum oxide, zirconium oxide, sheet silicate, and/or mixtures thereof.

5. The method according to claim 4, wherein the oxide particles are modified with ions from the group of the alkaline or alkaline-earth ions and/or with inorganic or organic salts that are present in compounds with aluminum, zirconium, zinc, or titanium.

6. The method according to claim 1, wherein the oxide particles are functionalized by the fact that functional groups of the organic side chains of epoxy, acryloxy, methacryloxy, glycidyloxy, alkyl, vinyl, carboxyl, mercapto, hydroxyl, amide, amino, isocyano, or silanol groups are inserted.

7. The method according to claim 1, wherein the oxide particles are present in the hydrophilizing agent in a proportion from 0.15 to 29.7 wt %.

8. The method according to claim 1, wherein the wetting agent is a surfactant, in particular a nonionic surfactant.

9. The method according to claim 8, wherein the nonionic surfactant is an ethoxylate or alkoxylate of primary and secondary fatty alcohols or of alkylphenols, an ethylene oxide/propylene oxide or propylene oxide/ethylene oxide block polymer, an aminoethoxylate, an aminoalkoxylate, an alkylpolyglycolide, a fatty amine oxide, a fatty acid alkanolamide, and/or a fatty acid alkylglucamide.

10. The method according to claim 8, wherein the surfactant is an end-capped surfactant in which the hydroxyl group is etherified with an alkyl group.

11. The method according to claim 1, wherein the wetting agent is present in the hydrophilizing agent at a concentration from 0.01 to 20 wt %.

12. A method for removing stencil material from a screen printing stencil carrier, in which a coating-removal fluid that contains a coating-removal agent and a wetting agent is applied onto the screen printing stencil carrier and onto the stencil material,
wherein a coating-removal fluid that additionally contains ultra-fine oxide particles is used.

13. The method according to claim 12, wherein the oxide particles have a particle size in the nanometer range.

14. The method according to claim 13, wherein the particle size of the oxide particles is from 2 to 100 nm, preferably 2 to 40 nm.

15. The method according to claim 12, wherein the oxide particles comprise metal oxide(s), in particular titanium oxide, aluminum oxide, zirconium oxide, sheet silicate, and/or mixtures thereof.

16. The method according to claim 15, wherein the oxide particles are modified with ions from the group of the alkaline or alkaline-earth ions and/or with inorganic or organic salts that are present in compounds with aluminum, zirconium, zinc, or titanium.

17. The method according to claim 12, wherein the oxide particles are functionalized by the fact that functional groups of the organic side chains of epoxy, acryloxy, methacryloxy, glycidyloxy, alkyl, vinyl, carboxyl, mercapto, hydroxyl, amide, amino, isocyano, or silanol groups are inserted.

18. The method according to claim 12, wherein the oxide particles are present in the coating-removal fluid in a proportion from 0.15 to 27 wt %.

19. The method according to claim 12, wherein the wetting agent is a surfactant, in particular a nonionic surfactant.

20. The method according to claim 19, wherein the nonionic surfactant is an ethoxylate or alkoxylate of primary and secondary fatty alcohols or of alkylphenols, an ethylene oxide/propylene oxide or propylene oxide/ethylene oxide block polymer, an aminoethoxylate, an aminoalkoxylate, an alkylpolyglycolide, a fatty amine oxide, a fatty acid alkanolamide, and/or a fatty acid alkylglucamide.

21. The method according to claim 19, wherein the surfactant is an end-capped surfactant in which the hydroxyl group is etherified with an alkyl group.

22. The method according to claim 12, wherein the wetting agent is present in the coating-removal fluid at a concentration from 0.01 to 20 wt %.

23. The method according to claim 12, wherein the coating-removal agent contains an oxidizing agent.

24. The method according to claim 23, wherein the oxidizing agent is at least one iodate, in particular a periodate, and/or a periodic acid.

25. The method according to claim 23, wherein the oxidizing agent is a sodium periodate, in particular sodium metaperiodate.

26. The method according to claim 23, wherein the oxidizing agent is present in the coating-removal fluid at a concentration from 0.1 to 5 wt %.

27. The method according to claim 12, wherein the coating-removal fluid additionally contains an organic solvent.

28. The method according to claim 27, wherein the organic solvent is selected from the group of the amides, ethers, esters, ether esters, and/or ketones (linear or cyclic).

29. The method according to claim 27, wherein the solvent is butyrolactone.

30. The method according to any of claims 27, wherein the solvent is present in the coating-removal fluid at a concentration from 1 to 30 wt %.

31. The method according to claim 12, wherein the coating-removal fluid contains sulfuric acid and/or nitric acid.

32. The method according to claim 31, wherein the sulfuric acid and/or nitric acid is present in the coating-removal fluid at a concentration from 0.1 to 5 wt %.

33. A coating-removal fluid, having a coating-removal agent and a wetting agent, for the removal of stencil material from a screen printing stencil carrier, wherein the coating-removal fluid contains ultra-fine oxide particles.

34. The coating-removal fluid according to claim 33, wherein the oxide particles have a particle size in the nanometer range.

35. The coating-removal fluid according to claim 33, wherein the particle size of the oxide particles is from 2 to 100 nm, preferably 2 to 40 nm.

36. The coating-removal fluid according to claim 33, wherein the oxide particles comprise metal oxide(s), in particular titanium oxide, aluminum oxide, zirconium oxide, sheet silicate, and/or mixtures thereof.

37. The coating-removal fluid according to claim 36, wherein the oxide particles are modified with ions from the group of the alkaline or alkaline-earth ions and/or with inorganic or organic salts that are present in compounds with aluminum, zirconium, zinc, or titanium.

38. The coating-removal fluid according to claim 33, wherein the oxide particles are functionalized by the fact that functional groups of the organic side chains f epoxy, acryloxy, methacryloxy, glycidyloxy, alkyl, vinyl, carboxyl, mercapto, hydroxyl, amide, amino, isocyano, or silanol groups are inserted.

39. The coating-removal fluid according to claim 33, wherein the oxide particles are present in the coating-removal fluid in a proportion from 0.15 to 27 wt %.

40. The coating-removal fluid according to claim 33, wherein the wetting agent is a surfactant, in particular a nonionic surfactant.

41. The coating-removal fluid according to claim 40, wherein the nonionic surfactant is an ethoxylate or alkoxylate of primary and secondary fatty alcohols or of alkylphenols, an ethylene oxide/propylene oxide or propylene oxide/ethylene oxide block polymer, an aminoethoxylate, an aminoalkoxylate, an alkylpolyglycolide, a fatty amine oxide, a fatty acid alkanolamide, and/or a fatty acid alkylglucamide.

42. The coating-removal fluid according to claim 40, wherein the surfactant is an end-capped surfactant in which the hydroxyl group is etherified with an alkyl group.

43. The coating-removal fluid according to claim 33, wherein the wetting agent is present in the coating-removal fluid at a concentration from 0.01 to 20 wt %.

44. The coating-removal fluid according to claim 33, wherein the coating-removal agent contains an oxidizing agent.

45. The coating-removal fluid according to claim 44, wherein the oxidizing agent is at least one iodate, in particular a periodate, and/or a periodic acid.

46. The coating-removal fluid according to claim 44, wherein the oxidizing agent is a sodium periodate, in particular sodium metaperiodate.

47. The coating-removal fluid according to claim 44, wherein the oxidizing agent is present in the coating-removal fluid at a concentration from 0.1 to 5 wt %.

48. The coating-removal fluid according to claim 33, wherein the coating-removal fluid additionally contains an organic solvent.

49. The coating-removal fluid according to claim 48, wherein the organic solvent is selected from the group of the amides, ethers, esters, ether esters, and/or ketones (linear or cyclic).

50. The coating-removal fluid according to claim 48, wherein the solvent is butyrolactone.

51. The coating-removal fluid according to claim 48, wherein the solvent is present in the coating-removal-fluid at a concentration from 1 to 30 wt %.

52. The coating-removal fluid according to claim 33, wherein-the coating-removal fluid contains sulfuric acid and/or nitric acid.

53. The coating-removal fluid according to claim 52, wherein the sulfuric acid and/or nitric acid is present in the coating-removal fluid at a concentration from 0.1 to 5 wt %.
